(19) United States
(12) Patent Application Publication
(10) Pub. No.: US 2025/0297576 A1
(43) Pub. Date: Sep. 25, 2025

(54) VARIABLE BLEED VALVE ASSEMBLIES

(71) Applicant: General Electric Company, Schenectady, NY (US)

(72) Inventors: Nageswar Rao Ganji, Bengaluru (IN); Hiranya Kumar Nath, Bengaluru (IN); Ravindra Ganiger, Bengaluru (IN); Vishnu Vardhan Venkata Tatiparthi, Bengaluru (IN); Jeffrey D. Carnes, Framingham, MA (US); Trevor Howard Wood, Niskayuna, NY (US)

(21) Appl. No.: 18/611,173

(22) Filed: Mar. 20, 2024

(51) Int. Cl. F02C 7/24; F02C 9/18

(52) U.S. Cl. CPC F02C 7/24; F02C 9/18; F05D 2260/606; F05D 2260/96

(57) ABSTRACT

Example variable bleed valve assemblies for a gas turbine engine are disclosed herein. An example variable bleed valve assembly includes a port extending radially outward from a main flow path of the gas turbine engine, a door positioned at an exit of the port, and an acoustic black hole (ABH) assembly coupled to the door. The ABH assembly includes a body and a plurality of plates coupled to an interior surface of the body. The body defines a cavity having a depth. Each of the plurality of plates has a surface area, and the plurality of plates are arranged such that the surface areas of the plurality of plates vary along the depth in a radially outward direction of the gas turbine engine.

### FIELD OF THE DISCLOSURE

This disclosure relates generally to turbine engines and, more particularly, to variable bleed valve assemblies.

### BACKGROUND

Turbine engines are some of the most widely used power generating technologies, often being utilized in aircraft and power-generation applications. For example, a turbofan engine is a type of turbine engine that generally includes a fan and a core arranged in flow communication with one another. The core of the turbine engine generally includes, in serial flow order, a compressor section, a combustion section, a turbine section on the same shaft as the compressor section, and an exhaust section. Typically, a casing or housing surrounds the core of the turbine engine.

### BRIEF DESCRIPTION OF THE DRAWINGS

FIG. 1 is a cross-sectional view of an example gas turbine engine in which examples disclosed herein may be implemented.

FIG. 2 is a partial cross-sectional side view of a compressor of the gas turbine engine example of FIG. 1 including a variable bleed valve assembly.

FIG. 3A is a side view of the compressor including the variable bleed valve assembly of FIG. 2.

FIG. 3B is a cross-sectional front view of the compressor including the variable bleed valve assembly of FIG. 2.

FIG. 4A is a partial cross-sectional side view of an example first variable bleed valve assembly including an example first acoustic black hole assembly in accordance with teachings disclosed herein.

FIG. 4B is a partial cross-sectional side view of an example second variable bleed valve assembly including an example second acoustic black hole assembly in accordance with teachings disclosed herein.

FIG. 5A is a cross-sectional front view of an example third variable bleed valve assembly including an example third acoustic black hole assembly in accordance with teachings disclosed herein.

FIG. 5B is a cross-sectional front view of an example fourth variable bleed valve assembly including an example fourth acoustic black hole assembly in accordance with teachings disclosed herein.

FIG. 6 is a cross-sectional front view of an example fifth variable bleed valve assembly including an example fifth acoustic black hole assembly in accordance with teachings disclosed herein.

FIG. 7 is a cross-sectional front view of an example sixth variable bleed valve assembly including an example sixth acoustic black hole assembly in accordance with teachings disclosed herein.

FIGS. 8A, 8B, 8C, 8D, 8E, 8F, 8G, 8H, 8I, and 8J illustrate various example acoustic black hole assemblies that can be implemented any of the example variable bleed valve assemblies disclosed herein. The example acoustic black hole assemblies of FIGS. 8A, 8B, 8C, 8D, 8E, 8F, 8G, 8H, 8I, and 8J have various plate arrangements, damping materials, structural damping layers, perforated sheets, wire mesh, and septa sheets.

FIG. 9 illustrates an example acoustic black hole assembly have a cylindrical shape.

FIG. 10 illustrates an example acoustic black hole assembly having a cuboid shape.

FIGS. 11A, 11B, 11C, 11D, and 11E illustrate various example acoustic black hole assemblies that can be implemented any of the example variable bleed valve assemblies disclosed herein. The example acoustic black hole assemblies of FIGS. 11A, 11B, 11C, 11D, and 11E have plates with various inner and outer diameter arrangements and perforated sheets.

FIG. 12A illustrates an example acoustic black hole assembly that can be implemented in any of the example variable bleed valve assemblies disclosed herein.

FIG. 12B illustrates an example plate of the example acoustic black hole assembly of FIG. 12A having a tapered outer peripheral section connected to an outer sidewall.

FIG. 12C illustrates an example plate of the example acoustic black hole assembly of FIG. 12A having an outer peripheral section with multiple connections to an outer sidewall.

FIG. 12D illustrates an example plate of the example acoustic black hole assembly of FIG. 12A constructed of a material of varying density and/or elasticity.

FIG. 13A illustrates an example acoustic black hole assembly with perforated plates that can be implemented in any of the example variable bleed valve assemblies disclosed herein.

FIG. 13B is a top view of an example plate of the example acoustic black hole assembly of FIG. 13A.

FIGS. 14A, 14B, 14C, and 14D illustrate various example acoustic black hole assemblies that can be implemented any of the example variable bleed valve assemblies disclosed herein. The example acoustic black hole assemblies of FIGS. 14A, 14B, 14C, and 14D have various chamber and plate arrangements.

FIG. 15 illustrates an example acoustic black hole assembly having branched chambers that can be implemented any of the example variable bleed valve assemblies disclosed herein.

The figures are not drawn to scale. Instead, the thickness of the layers or regions may be enlarged in the drawings. Although the figures show layers and regions with clean lines and boundaries, some, or all of these lines and/or boundaries may be idealized. In reality, the boundaries and/or lines may be unobservable, blended, and/or irregular. In general, the same reference numbers will be used throughout the drawing(s) and accompanying written description to refer to the same or like parts. As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween. As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In some examples used herein, the term “substantially” is used to describe a relationship between two parts that is, for example, within three degrees of the stated relationship (e.g., a substantially collinear relationship is within three degrees of being linear, a substantially perpendicular relationship is within three degrees of being perpendicular, a substantially same relationship is within three degrees of being the same, a substantially flush relationship is within three degrees of being flush, etc.). In some examples used herein, the term “substantially” is used to mean to a great or significant effect.

As used herein, the terms “upstream” and “downstream” refer to locations along a fluid flow path relative to a direction of fluid flow from a first location to a second location. For example, with respect to a fluid flow, “upstream” refers to the first location from which the fluid flows, and “downstream” refers to the second location toward which the fluid flows. For example, with regard to a gas turbine engine, a compressor is said to be upstream of a turbine relative to a flow direction of air flowing through the engine.

Various terms are used herein to describe the orientation of features. In general, the attached figures are annotated with reference to the axial direction, radial direction, and circumferential direction of the vehicle associated with the features, forces, and moments. In general, the attached figures are annotated with a set of axes including the axial axis A, the radial axis R, and the circumferential axis C.

In the following detailed description, reference is made to the accompanying drawings that form a part hereof, and in which is shown by way of illustration specific examples that may be practiced. These examples are described in sufficient detail to enable one skilled in the art to practice the subject matter, and it is to be understood that other examples may be utilized. The following detailed description is therefore provided to describe an exemplary implementation and not to be taken limiting on the scope of the subject matter described in this disclosure. Certain features from different aspects of the following description may be combined to form yet new aspects of the subject matter discussed below.

### DETAILED DESCRIPTION

A turbine engine, also referred to herein as a gas turbine engine, is a type of continuous flow internal combustion engine that uses atmospheric air as a moving fluid. In operation, atmospheric air enters the turbine engine via a fan and flows through a compressor section where one or more compressors progressively compress (e.g., pressurize) the air until it reaches the combustion section. In the combustion section, the pressurized air is combined with fuel and ignited to produce a high-temperature, high-pressure gas stream (e.g., hot combustion gas) before entering the turbine section. The hot combustion gases expand as they flow a through a turbine section, causing rotating blades of one or more turbines to spin. The rotating blades of the turbine produce a spool work output that powers a corresponding compressor. The spool is a combination of the compressor, a shaft, and the turbine. Turbine engines often include multiple spools, such as a high pressure spool (e.g., HP compressor, shaft, and turbine) and a low pressure spool (e.g., LP compressor, shaft, and turbine). However, a turbine engine can include one spool or more than two spools in additional or alternative examples.

During low speed operation of the turbine engine (e.g., during start-up and/or stopping), equilibrium of the engine is adjusted. In many scenarios, a delay is needed for the spool(s) to adapt (e.g., a time for a rotational speed to adjust for a new equilibrium). However, the compressor continues to provide pressurized air for fuel combustion during operation. Such a result may cause the turbine to stop producing the power to turn the compressor, causing the compressor itself to stop compressing air. Accordingly, throttling changes may lead to compressor instabilities, such as compressor stall and/or compressor surge. Compressor stall is a circumstance of abnormal airflow resulting from the aerodynamic stall of rotor blades within the compressor. Compressor stall causes the air flowing through the compressor to slow down or stagnate. In some cases, the disruption of air flow as the air passes through various stages of the compressor can lead to compressor surge. Compressor surge refers to a stall that results in disruption (e.g., complete disruption, majority disruption, other partial disruption, etc.) of the airflow through the compressor.

Gas turbine engines include a variable bleed valve (VBV) that is integrated into the compressor (e.g., at a downstream end of the LP compressor) to increase efficiency and limit possible stalls. The VBV enables the turbine engine to bleed air from the compressor section during operation. An example VBV assembly includes a VBV port (e.g., opening, air bleed slot, etc.) including a VBV cavity extending from a compressor casing and a VBV door that opens via actuation. In other words, the VBV is configured as a cavity with a door that opens to provide a bleed flow path to bleed off compressed air between a booster (e.g., a low pressure compressor) and a core engine compressor of a gas turbine. For example, the VBV door may be actuated during a speed-to-speed mismatch between the LP spool and the HP spool from their design speed equilibrium. Speed-to-speed mismatch occurs during low speed operation or during the deceleration, for example, when the HP spool decelerates sooner or out of proportion or relation to the LP spool, such that the mass flow rate through the core falls out of its intended equilibrium. This results in the LP compressor attempting to pump too high of a mass flow rate to the HP compressor and potentially causing HP compressor surge, or the reduced HP core mass flow could drive the LP compressor to stall. To help equilibrate this mismatch, the VBV allows some mass flow from the LP compressor (booster) to bypass the core compressor to maintain normal operation of the turbomachinery in the engine. In other words, opening the VBV port allows the LP spool to maintain its speed while reducing the amount of air that is flowing through the HP compressor by directing some of the air flow to the other engine components (e.g., the bypass, the turbine, turbine exhaust area etc.). Thus, the VBV door enables the LP spool (e.g., booster) to operate on a lower operating throttle line and reduces the likelihood of a potential instability or stall condition.

In some VBV ports, the VBV door is not flush with the compressor casing, resulting in a bleed cavity that is open to a main flow path within the compressor. When the VBV door is closed, air of the main flow path flows over an opening of the VBV cavity. This causes the VBV port to acoustically resonate at a fixed frequency or a set of frequencies, similar to blowing air over an empty bottle. Such a phenomenon is referred to as resonance. More specifically, a shear layer of the air flow separates from the upstream edge and impinges on a downstream edge of the VBV port, resulting in acoustic wave feedback. This shear layer feedback resonates with the air within the VBV cavity, resulting in energetic acoustic tones that emanate from the bleed cavity. The oscillations/acoustic tones can be amplified based on the geometry of the VBV cavity and/or acoustically excite the air in the engine core. At certain resonant frequencies, acoustic excitations can also resonate with mechanical vibrations of the rotor system (e.g., rotor blades, rotor disks, rotor blisks (integrated rotor disk and blades), etc.) in the LP compressor. In some cases, the mechanical vibrations propagate and/or intensify upstream along the rotor system toward one of the rotor disks (e.g., the initial rotor disk). Such resonant mechanical excitation of the LP compressor hardware can cause increased stress levels and induce crack formation and damage the rotor system and/or reduce booster performance. For example, one or more rotor blades of the rotor stage can crack due to excessive mechanical vibrations from the acoustic resonance of a closed-off VBV port (e.g., VBV cavity). Accordingly, new VBV assemblies are needed to reduce the resonant frequencies of the VBV cavity when the VBV door is closed.

Disclosed herein are example VBV assemblies that include an acoustic black hole (ABH) assembly coupled to a VBV door to reduce the VBV cavity acoustic resonance response. More specifically, an example ABH assembly can receive and dampen incident (e.g., incoming) acoustic wave energy such that waves are reflected as substantially weakened acoustic waves or fully absorbed, which avoids the problem of these cavity frequencies resonating energetically with LP compressor/LP compressor components outside of the VBV cavity. In some examples, an ABH assembly includes a plurality of plates (e.g., fins, baffles, etc.) coupled to interior walls of a housing to vibrate based on the acoustic resonance of the VBV cavity. In some examples, the plates have varying surface area and/or sizes along the depth of the VBV cavity (e.g., the plate sizes increase in the radial outward direction). The oscillation of the plates drives the acoustic waves into the ABH cavity and converts the acoustic energy into mechanical and heat energy that is subsequently dissipated. Hence, the acoustic/aeromechanical feedback energy is reduced completely or significantly.

As used herein, an “acoustic black hole” refers to a system, device, and/or assembly used for passively controlling acoustic response or vibrations in the cavity. In some examples, a local inhomogeneity is embedded in a thin-walled structure, such as a disc, a fin, a beam, or a plate, to construct an ABH. In some examples, the thin-walled structure is positioned within a body of the ABH, such as an open-top cylinder. The inhomogeneity can be a variation of the geometric or material properties of the thin-walled structure according to a spatial power law profile. Furthermore, the thin-walled structure can include one or more layers of viscoelastic materials. Such a thin-walled structure provides attenuation properties to the ABH. In other words, the ABH reduces the speed of elastic waves (e.g., acoustic waves) that travel within the ABH. When the thickness of the thin-walled structure reduces to zero at the ABH center, the wave speed decreases to zero. When the ABH has a non-zero residual thickness at its center, the wave speed decreases but does not vanish. Thus, in some examples, the ABH (e.g., thin-walled structure, etc.) is combined with lossy media (e.g. viscoelastic layers) to improve structural loss factors. In other words, the ABH operates as a wave trap that extracts and dissipates vibrational energy from the host medium (e.g., air) without releasing or reflecting the energy.

Example VBV assemblies disclosed herein dampen the acoustic response of the air within the VBV cavity to reduce the oscillations of the air within the booster/LP compressor when the VBV door is in the closed position. Thus, disclosed examples enable the manufacture of VBV assemblies that reduce vibration of the LP compressor or booster at various resonant frequencies of the VBV cavity. In other words, example VBV assemblies disclosed herein reduce vibrational damage imparted to a rotor system of a booster/LP compressor.

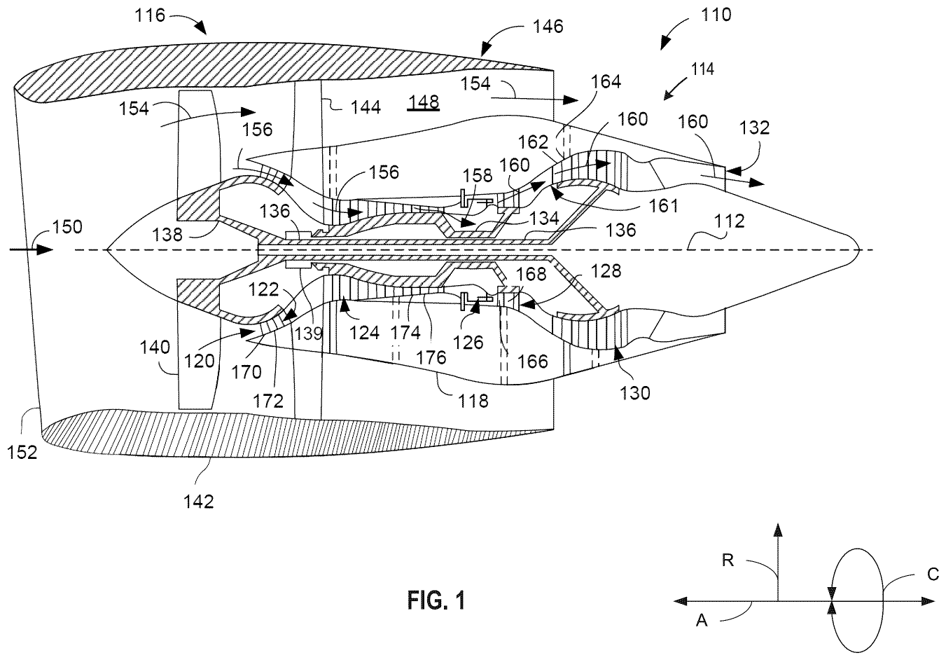

Referring now to the drawings, wherein identical numerals indicate the same elements throughout the figures, FIG. 1 is a schematic cross-sectional view of an example high-bypass turbofan-type gas turbine engine 110 (“turbofan engine 110”). While the illustrated example is a high-bypass turbofan engine, the principles of the present disclosure are also applicable to other types of engines, such as low-bypass turbofans, turbojets, turboprops, etc. As shown in FIG. 1, the turbofan engine 110 defines a longitudinal or axial centerline axis 112 extending therethrough for reference. FIG. 1 also includes an annotated directional diagram with reference to an axial direction A, a radial direction R, and a circumferential direction C. In general, as used herein, the axial direction A is a direction that extends generally parallel to the centerline axis 112, the radial direction R is a direction that extends orthogonally outwardly from the centerline axis 112, and the circumferential direction C is a direction that extends concentrically around the centerline axis 112.

In general, the turbofan engine 110 includes a core turbine or gas turbine engine 114 disposed downstream from a fan section 116. The core turbine 114 includes a substantially tubular outer casing 118 that defines an annular inlet 120. The outer casing 118 can be formed from a single casing or multiple casings. The outer casing 118 encloses, in serial flow relationship, a compressor section having a booster or low pressure compressor 122 (“LP compressor 122”) and a high pressure compressor 124 (“HP compressor 124”), a combustion section 126, a turbine section having a high pressure turbine 128 (“HP turbine 128”) and a low pressure turbine 130 (“LP turbine 130”), and an exhaust section 132. A high pressure shaft or spool 134 (“HP shaft 134”) drivingly couples the HP turbine 128 and the HP compressor 124. A low pressure shaft or spool 136 (“LP shaft 136”) drivingly couples the LP turbine 130 and the LP compressor 122. The LP shaft 136 can also couple to a fan spool or fan shaft 138 of the fan section 116. In some examples, the LP shaft 136 is coupled directly to the fan shaft 138 (e.g., a direct-drive configuration). In alternative configurations, the LP shaft 136 can couple to the fan shaft 138 via a reduction gear 139 (e.g., an indirect-drive or geared-drive configuration).

As shown in FIG. 1, the fan section 116 includes a plurality of fan blades 140 coupled to and extending radially outwardly from the fan shaft 138. An annular fan casing or nacelle 142 circumferentially encloses the fan section 116 and/or at least a portion of the core turbine 114. The nacelle 142 can be supported relative to the core turbine 114 by a plurality of circumferentially spaced apart outlet guide vanes 144. Furthermore, a downstream section 146 of the nacelle 142 can enclose an outer portion of the core turbine 114 to define a bypass airflow passage 148 therebetween.

As illustrated in FIG. 1, air 150 enters an inlet portion 152 of the turbofan engine 110 during operation thereof. A first portion 154 of the air 150 flows into the bypass airflow passage 148, while a second portion 156 of the air 150 flows into the inlet 120 of the LP compressor 122. One or more sequential stages of LP compressor stator vanes 170 and LP compressor rotor blades 172 coupled to the LP shaft 136 progressively compress the second portion 156 of the air 150 flowing through the LP compressor 122 en route to the HP compressor 124. Next, one or more sequential stages of HP compressor stator vanes 174 and HP compressor rotor blades 176 coupled to the HP shaft 134 further compress the second portion 156 of the air 150 flowing through the HP compressor 124. This provides compressed air 158 to the combustion section 126 where it mixes with fuel and burns to provide combustion gases 160.

The combustion gases 160 flow through the HP turbine 128 where one or more sequential stages of HP turbine stator vanes 166 and HP turbine rotor blades 168 coupled to the HP shaft 134 extract a first portion of kinetic and/or thermal energy therefrom. This energy extraction supports operation of the HP compressor 124. The combustion gases 160 then flow through the LP turbine 130 where one or more sequential stages of LP turbine stator vanes 162 and LP turbine rotor blades 164 coupled to the LP shaft 136 extract a second portion of thermal and/or kinetic energy therefrom. This energy extraction causes the LP shaft 136 to rotate, thereby supporting operation of the LP compressor 122 and/or rotation of the fan shaft 138. The combustion gases 160 then exit the core turbine 114 through the exhaust section 132 thereof. A turbine frame 161 with a fairing assembly is located between the HP turbine 128 and the LP turbine 130. The turbine frame 161 acts as a supporting structure, connecting a high-pressure shaft's rear bearing with the turbine housing and forming an aerodynamic transition duct between the HP turbine 128 and the LP turbine 130. Fairings form a flow path between the high-pressure and low-pressure turbines and can be formed using metallic castings (e.g., nickel-based cast metallic alloys, etc.).

Along with the turbofan engine 110, the core turbine 114 serves a similar purpose and is exposed to a similar environment in land-based gas turbines, turbojet engines in which the ratio of the first portion 154 of the air 150 to the second portion 156 of the air 150 is less than that of a turbofan, and unducted fan engines in which the fan section 116 is devoid of the nacelle 142. In each of the turbofan, turbojet, and unducted engines, a speed reduction device (e.g., the reduction gear 139) can be included between any shafts and spools. For example, the reduction gear 139 is disposed between the LP shaft 136 and the fan shaft 138 of the fan section 116.

As described above with respect to FIG. 1, the turbine frame 161 is located between the HP turbine 128 and the LP turbine 130 to connect the high-pressure shaft's rear bearing with the turbine housing and form an aerodynamic transition duct between the HP turbine 128 and the LP turbine 130. As such, air flows through the turbine frame 161 between the HP turbine 128 and the LP turbine 130.

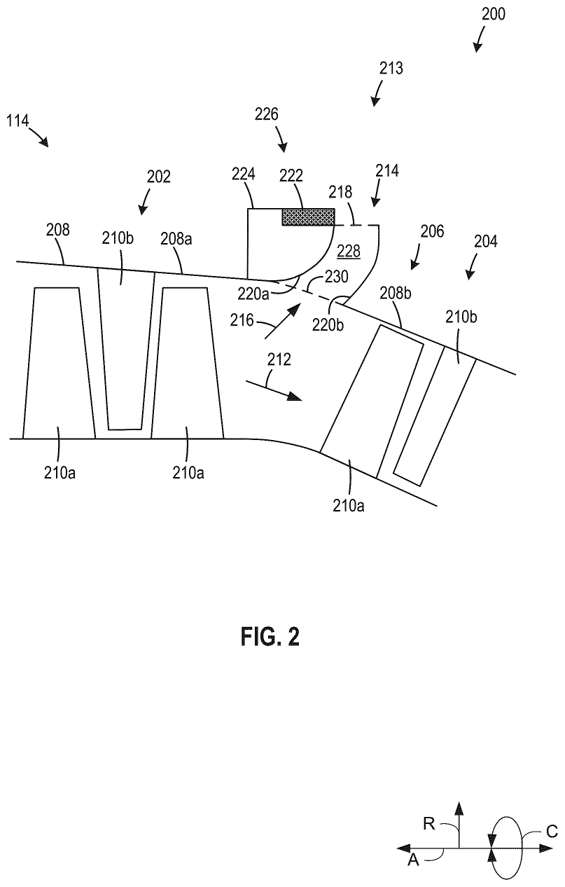

FIG. 2 is a partial cross-sectional view of an example compressor 200 of a turbine engine (e.g., the turbofan engine 110 of FIG. 1), including an example LP compressor or booster section 202 and an example HP compressor section 204. The booster section 202 and the HP compressor section 204 may correspond to the LP compressor 122 and the HP compressor 124 of the turbofan engine 110 of FIG. 1. FIG. 2 illustrates the example compressor 200 at a transition point 206 between the booster section 202 and the HP compressor section 204. The compressor 200 includes an example casing 208. In the illustrated example of FIG. 2, the booster casing 208a surrounds the booster section 202 and the HP compressor section 204. In some examples, the booster section 202 and the HP compressor section 204 have distinct casings 208 connected via a linkage mechanism. For example, as shown in FIG. 2, the casing 208 has a first casing, referred to herein as a booster casing 208a, and a second casing 208b, referred to herein as a compressor casing 208b. The casing 208 surrounds rotor blades 210a and stator vanes 210b of the compressor 200. In operation, the rotor blades 210a spin, which impels air downstream. The stator vanes 210b redirect and reduce the airflow velocity, which increases the pressure downstream. The casing 208 defines an example main flow path 212 (e.g., a first flow path) for airflow through compressor 200 (e.g., and the turbofan engine 110).

As illustrated in example FIG. 2, a VBV assembly 213 of the gas turbine engine 114 includes a VBV port 214 (e.g., passage, opening, duct, etc.) to divert air from the main flow path 212 and circumvent the HP compressor section 204. The VBV port 214 defines an example bleed flow path 216 (e.g., secondary flow path) between the booster section 202 and a VBV port exit 218. More specifically, the VBV port 214 includes a fore VBV wall 220a and an aft VBV wall 220b extending radially outward between the booster section 202 and the VBV port exit 218. In some examples, the fore and aft VBV walls 220a, 220b define an annular geometry of the VBV port 214.

In the illustrated example of FIG. 2, the VBV assembly 213 includes a VBV door 222 to restrict or permit airflow through the bleed flow path 216. The VBV assembly 213 includes a VBV actuation system 224 to actuate the VBV door 222 between an opened position 226 and a closed position. For example, the VBV actuation system 224 can include one or more levers (e.g., a bell crank, etc.), linkages, and/or other actuation device(s) to slide the VBV door 222 between the opened position 226 and the closed position. Thus, the VBV door 222 is actuatable (e.g., movable, translatable, rotatable, etc.) between the opened position 226 and the closed position.

In the illustrated example of FIG. 2, the VBV door 222 and a VBV actuation system 224 are located adjacent to the VBV port exit 218. The VBV actuation system 224 causes the VBV door 222 (e.g., blocker door, etc.) to move to the closed position to cover the VBV port exit 218. When the VBV door 222 is in the closed position, the bleed flow path 216 is blocked and air is relatively stagnant in the VBV port 214 compared to the main flow path 212. In some examples, the VBV door 222, the fore VBV wall 220a, and the aft VBV wall 220b of the VBV port 214 define an example VBV cavity 228 (also referred to as a bleed cavity) when in the VBV door 222 is in the closed position. Thus, a shear layer of airflow separates from the cavity entrance, at the fore VBV wall 220a, and impinges on the edge of the aft VBV wall 220b, resulting in acoustic wave feedback. The feedback resonates with VBV cavity 228, and energetic acoustic tones emanate from VBV cavity 228, which extends across an entrance 230 to the VBV port 214 and substantially confines a pocket of air within the VBV cavity 228. Air flow along the main flow path 212 and the shear layer oscillates and causes the air within the VBV cavity 228 to resonate at various frequencies. Such acoustic resonance of the VBV cavity 228 can lead to acoustic excitations in the booster section 202 and compressor hardware. Advantageously, example VBV assemblies disclosed herein include acoustic black holes to attenuate the acoustic resonance of the VBV cavity 228.

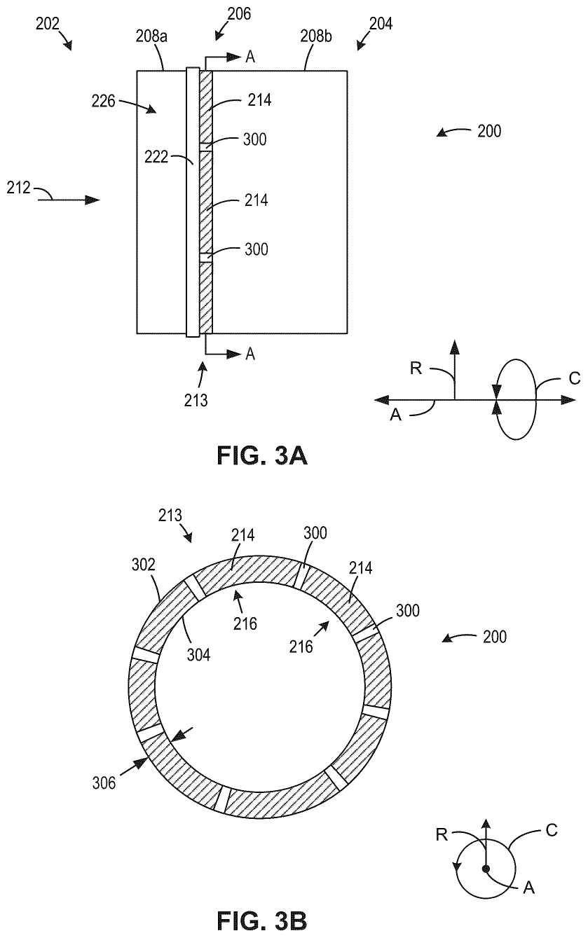

FIG. 3A is a side view of the example compressor 200 of FIG. 2 including a first variable bleed valve (VBV) assembly 213 that can be implemented in a turbine engine (e.g., turbofan engine 110 of FIGS. 1 and/or 2). FIG. 3B is a cross-sectional front view of the example compressor 200 of FIG. 3A taken along line A-A. In the illustrated examples, of FIGS. 3A and 3B, the VBV door 222 is in the opened position 226. Thus, the VBV door 222 is not visible in FIG. 3B.

In the illustrated examples of FIGS. 3A and 3B, the booster casing 208a surrounds the booster section 202 of the compressor 200, and the compressor casing 208b surrounds the HP compressor section 204 of the compressor 200. The booster casing 208a is coupled to the compressor casing 208b at the transition point 206. The VBV assembly 213 includes one or more VBV ports 214 integrated into the casing 208 to bleed air from the main flow path 212. In some examples, the VBV ports 214 are formed at the transition point 206 between the booster and compressor casings 208a, 208b. For example, the booster casing 208a can include the fore VBV wall 220a (FIG. 2) and the compressor casing 208b can include the aft VBV wall 220b (FIG. 2). Thus, the VBV ports 214 can be created based on a coupling of the casings 208a, 208b. In some examples, the VBV ports 214 are machined into the casing 208. In some examples, an additive manufacturing process integrates the VBV ports 214 into the casing 208. Additionally or alternatively, the VBV ports 214 can be manufactured separately and coupled (e.g., welded, bolted, etc.) to the casing 208.

In some examples, the VBV assembly 213 selectively bleeds air based on a number of the VBV ports 214. For example, the casing 208 can include between 8 and 18 VBV ports 214 based on a target bleed flowrate. In some examples, respective ones of the VBV ports 214 include a door that can actuate between an open and closed position to adjust the bleed flowrate of the VBV assembly 213 based on a target bleed flowrate and/or a flight condition of the aircraft. In some examples, the VBV assembly 213 includes a single unified VBV port 214 that continually extends circumferentially about a longitudinal axis of the compressor 200 (e.g., the centerline axis 112 of FIG. 1). In the illustrated examples of FIGS. 3A and 3B, the VBV assembly 213 includes a plurality of partitions 300 (e.g., struts, ribs, support beams, etc.) to define the VBV ports 214. That is, the partitions 300 circumferentially separate and define adjacent ones of the VBV ports 214. The plurality of partitions 300 are spaced circumferentially about compressor 200 at a substantially similar axial and radial positions.

In the illustrated example of FIG. 3B, the booster casing 208a and the compressor casing 208b include an example outer surface 302 and an example inner surface 304. In the example of FIG. 3B, a dimension 306 of FIG. 3B corresponds to a thickness of the casings 208a, 208b and/or a radial length of the VBV ports 214. For example, the compressor casing 208b expands radially outward by the dimension 306 from the inner surface 304 to the outer surface 302. In some examples, the VBV ports 214 extend radially beyond the outer surface 302 and have a radial length that is greater than the dimension 306.

In the illustrated example of FIG. 3B, each of the VBV ports 214 includes the VBV cavity 228 of FIG. 2. In some examples, the VBV ports 214 are similarly sized and the VBV cavities 228 have similar volumes. Alternatively, ones of the VBV ports 214 can have variable sizes and ones of the VBV cavities 228 have different volumes based on respective positions of the partitions 300. However, in some examples, the VBV assembly 213 includes the single (e.g., unified, continuous, etc.) VBV port 214 such that the VBV cavity 228 extends circumferentially about the longitudinal axis of the compressor 200.

Various example VBV assemblies in accordance with the teachings of this disclosure are described in further detail below. Examples disclosed below are applied to the example compressor 200 of the example turbofan engine 110 as described in FIGS. 2, 3A, and 3B. Accordingly, examples disclosed below include the example casing 208 (e.g., the booster casing 208a and the compressor casing 208b), which defines the main flow path 212, and the example VBV port(s) 214, which defines the example bleed flow path 216. It is understood, however, that examples disclosed herein may be implemented in one or more compressors, such as a high pressure compressor, a low pressure compressor, etc. Further, examples disclosed herein may be implemented on a compressor having a variety of configurations, such as including one or more VBV ports, compressor stages, etc. Further, examples disclosed herein may be applied to a variety of turbine engines, such as a multi-spool turbine engine, a turboshaft engine, turbine engines with one compressor section, etc. Examples disclosed below may include the controller to determine to actuate the VBV assemblies disclosed herein.

The VBV ports 214 of the VBV assembly 213 of FIGS. 2, 3A, and 3B can resonate at an acoustic frequency based on the volume of the VBV cavity 228. That is, when the VBV door 222 is in the closed position and air flows across the entrance 230 (FIG. 2), the VBV port 214 of FIG. 2 resonates at the acoustic frequency, also referred to herein as the resonant frequency. Thus, the VBV assembly 213 can generate airwave oscillations in the booster section 202 of the compressor 200 that excite the mechanical components (e.g., rotor blades 210a, stator vanes 210b, etc.) of the booster section 202.

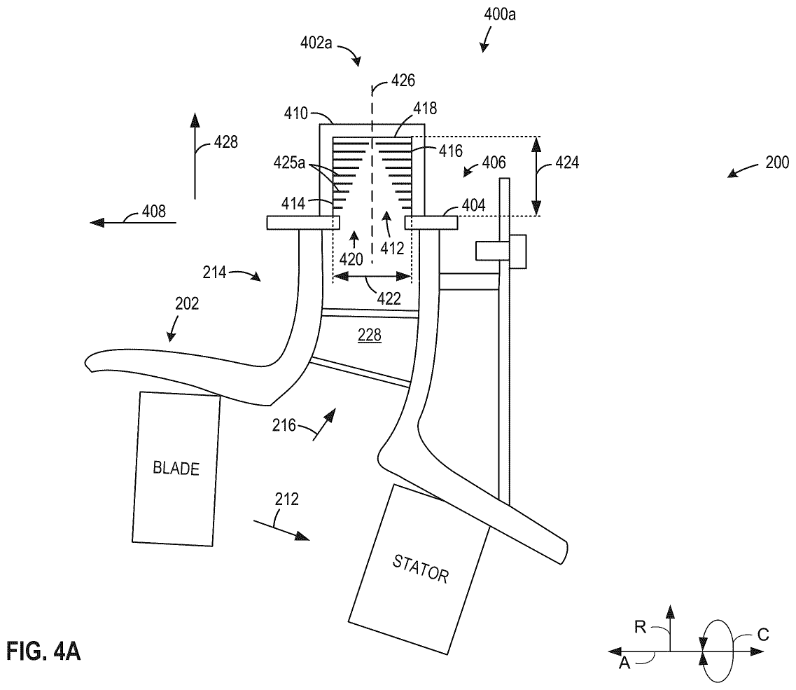

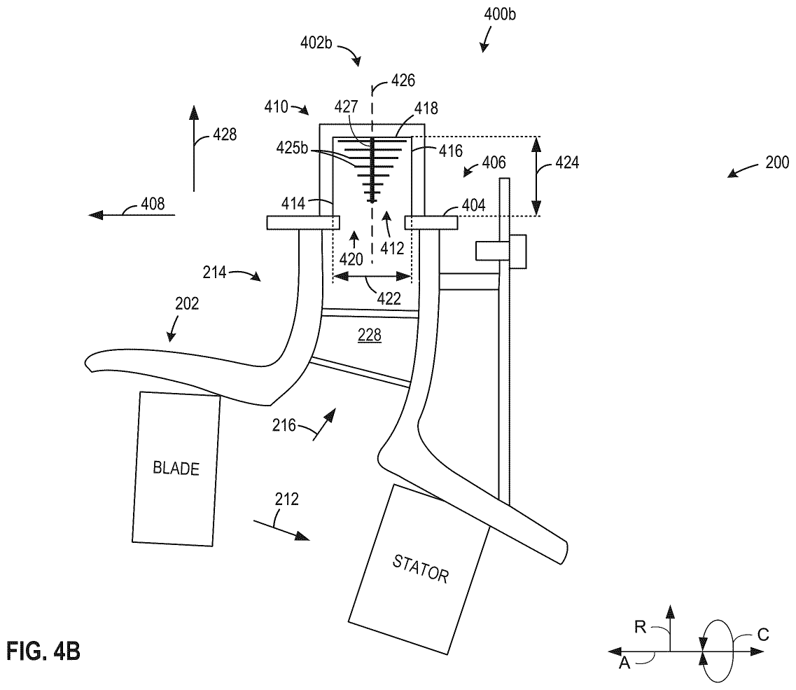

FIG. 4A is a partial cross-sectional side view of the example compressor 200 of FIG. 2 including an example first VBV assembly 400a in accordance with teachings disclosed herein. FIG. 4B is a partial cross-sectional side view of the example compressor 200 of FIG. 2 including an example second VBV assembly 400b in accordance with teachings disclosed herein. Many of the components of the example first VBV assembly 400a of FIG. 4A and the example second VBV assembly 400b of FIG. 4B are substantially similar or identical to the components described above in connection with the VBV assembly 213 of FIGS. 2, 3A, and 3B. As such, those components will not be described in detail again below. Instead, the interested reader is referred to the above corresponding descriptions for a complete written description of the structure and operation of such components. To facilitate this process, similar or identical reference numbers will be used for like structures in FIGS. 4A and 4B as used in FIGS. 2, 3A, and 3B. For the figures disclosed herein, identical numerals indicate the same elements throughout the figures.

The first VBV assembly 400a of FIG. 4A includes a first acoustic black hole (ABH) assembly 402a coupled to a door 404. The second VBV assembly 400b of FIG. 4B includes a second ABH assembly 402b coupled to the door 404. In the illustrated examples of FIGS. 4A and 4B, the first ABH assembly 402a and the second ABH assembly 402b include similar and/or identical elements. Thus, descriptions in connection with the first ABH assembly 402a of FIG. 4A can apply to like elements of the second ABH assembly 402b of FIG. 4B that have the same reference numbers. Furthermore, the first ABH assembly 402a and the second ABH assembly 402b have similar functionalities and/or advantages. Thus, unless otherwise specified, operational descriptions of the first ABH assembly 402a can likewise apply to the second ABH assembly 402b.

In FIGS. 4A and 4B, the door 404 is shown in a closed position 406. In some examples, the door 404 is actuatable in a forward direction 408 via an actuation system (e.g., the VBV actuation system 224 of FIG. 2). Thus, the door 404 can move between the closed position 406 and an opened position (e.g., full forward position). When the door 404 is in the closed position 406, the first ABH assembly 402a absorbs resonant sound waves produced in the VBV port 214.

The first ABH assembly 402a of the illustrated example includes a body 410 defining an ABH cavity 412. More specifically, the body 410 includes a fore interior surface 414, an aft interior surface 416, and a radially outer surface 418 (e.g., a ceiling) forming a rectangular cross-sectional profile of the ABH cavity 412. In some examples, the radially outer surface 418 is curved to form a domed cap of the body 410. In some examples, the body 410 includes a single curved interior wall forming a domed cross-sectional profile of the ABH cavity 412. In some examples, the door 404 includes one or more openings 420 (e.g., apertures, holes, slots, etc.) to permit airflow into and out of the ABH cavity 412.

In the illustrated examples, the first ABH assembly 402a is an annular ABH assembly extending circumferentially about a longitudinal axis (e.g., centerline axis 112) of a gas turbine engine (e.g., turbofan engine 110 of FIG. 1). Thus, the body 410 can extend circumferentially about the longitudinal axis. Furthermore, the fore and aft interior surface 414, 416 are discrete walls such that the fore interior surface 414 is separated from the aft interior surface 416 by a first dimension 422. For example, the first dimension 422 corresponds to an inner width of the body 410. In some examples, the fore and aft interior surfaces 414, 416 are substantially parallel (e.g., within +/−10%, etc.). In some examples, the fore and aft interior surfaces 414, 416 are askew such that the first dimension 422 is variable along a second dimension 424 (e.g., depth) of the body 410.

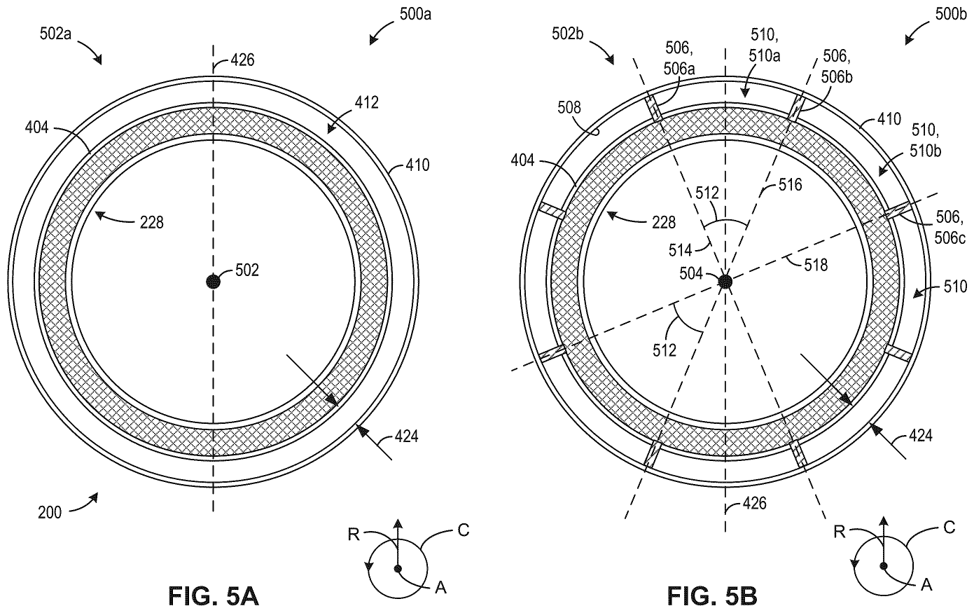

In some examples, the first ABH assembly 402a is an ABH plug assembly rather than an annular assembly. For example, the body 410 can be an axisymmetric cylinder aligned with a radial axis of the gas turbine engine. Thus, the fore interior surface 414 can correspond to a single unified interior wall of a cylindrical structure. When the example first ABH assembly 402a corresponds to an ABH plug assembly, the first dimension 422 is an inner diameter of the body 410. Further details describing the example annular, plug, and/or other configurations of the first ABH assembly 402a are provided below in connection with FIGS. 5A, 5B, 6, and 7.

The first ABH assembly 402a of the illustrated example of FIG. 4A includes a first plurality of plates 425a (which may also be referred to as fins or baffles) to guide acoustic waves into the ABH cavity 412. Furthermore, the first plates 425a dissipate acoustic energy generated in the VBV port 214. Such acoustic energy can correspond to air pressure fluctuations that propagate from the VBV cavity 228 and that oscillate at the resonant frequency of the VBV port 214.

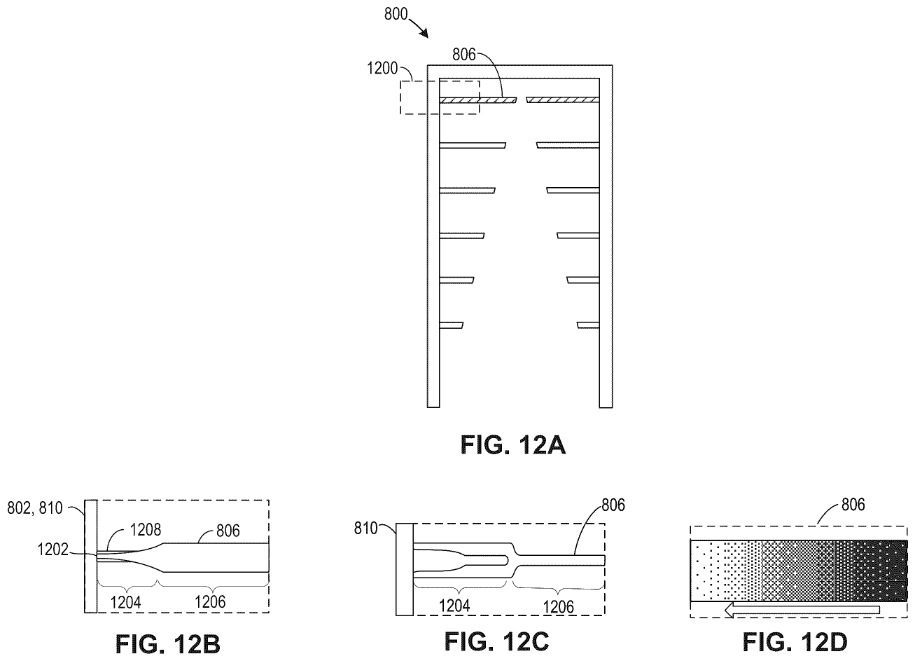

In the illustrated example of FIG. 4A, a first set of the first plates 425a are coupled to the fore interior surface 414 and a second set of the first plates 425a are coupled to the aft interior surface 416 of the body 410. Thus, the first plates 425a extend circumferentially along the annular shape of the body 410 and the fore and aft interior surfaces 414, 416. Furthermore, the first plates 425a extend axially outward from the fore and aft interior surfaces 414, 416 and into the ABH cavity 412. For example, the first plates 425a are rings surrounding the door 404 and protruding inward (e.g., toward the lateral axis 426) from the fore and aft interior surfaces 414, 416 of the body 410. In some examples, the plates 425a have a tapered or wedged profile. That is, the plates 425a can decrease in thickness along a span of the plates 425a. For example, a thickness profile of the plates 425a can decrease from a base (e.g., at the fore interior surface 414) to a pointed tip. In some examples, the thickness of the plates 425a decreases from root to tip according to a power law relationship of the thickness as a function of the distance from the root. Examples of these changes in thickness are disclosed in further detail herein in connection with FIGS. 12A-12D.

In the illustrated example of FIG. 4A, each of the first plates 425a has a surface area (viewed in the radially outward direction 428), and the first plates 425a are arranged such that the surface areas of the plates 425a vary (e.g., increase or decrease) along the depth in the radially outward direction 428. Said another way, the plates 425a have variable surface areas along the second dimension 424 (e.g., the depth) in a radially outward direction 428 of the gas turbine engine 114 (FIG. 1). In the illustrated example, the first plates 425a are arranged such that the surface areas of the first plate 425a increase in size along a lateral axis 426 in the radially outward direction 428. The first plates 425a of FIG. 4A are cantilevered rings increasing in span (e.g., axial length) along the lateral axis 426 and in the radially outward direction 428.

In the illustrated example of FIG. 4B, the second ABH assembly 402b includes a second plurality of plates 425b having variable size along the second dimension 424 (e.g., depth) of the body 410 in the radially outward direction 428. In the illustrated example, the second plates 425b are arranged in a center of the ABH cavity 412 and increase in size along the lateral axis 426 in the radially outward direction 428. In some examples, the second plates 425b are coupled to a post 427 extending from the radially outer surface 418. Similar to the configuration in FIG. 4A, the open area in the ABH cavity 412 decreases in the radially outward direction because of the increasing size of the plates.

The first ABH assembly 402a of FIG. 4A includes a first portion of the first plates 425a coupled to the fore interior surface 414 and a second portion of the first plates 425a coupled to the aft interior surface 416. In the illustrated examples, ones of the first set of the first plates 425a are aligned with respective ones of the second set of the first plates 425a. In some examples, the first and second sets of the first plates 425a are misaligned or offset in the axial direction.

The first plurality of plates 425a within the ABH cavity 412 vibrate based on the acoustic resonance of the VBV cavity 228. The vibrating first plates 425a drive or guide incident (e.g., incoming) acoustic waves into the ABH cavity 412 to impact the radially outer surface 418. After the sound waves impact the radially outer surface 418 and/or the fore and aft interior surfaces 414, 416, pressure oscillations reflect off of the interior surfaces 414-418 and reverberate within the body 410. The reflected and reverberated sound waves cause the first plates 425a to oscillate or vibrate, which converts acoustic energy into heat (e.g., within the air and/or the plates 425a). As the acoustic energy dissipates, so does the amplitude and/or frequency of the acoustic waves. Thus, the acoustic waves either reflect back out of the ABH cavity 412 with reduced frequency (e.g., energy) or are absorbed within the body 410. In some examples, the first plates 425a dampen incident sound waves to such an extent that the resonant tone is quieted before or upon reaching the radially outer surface 418.

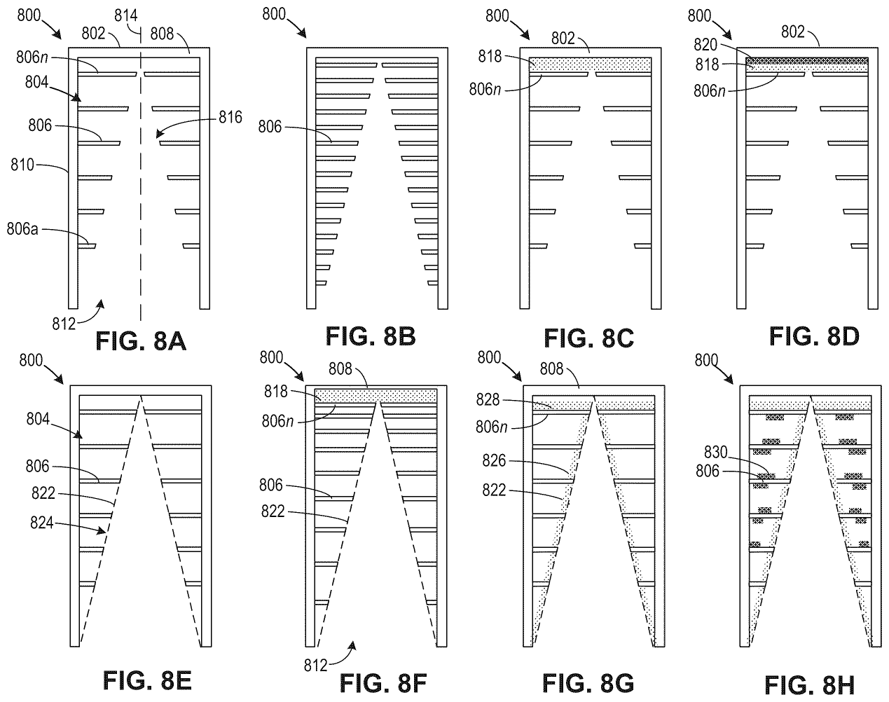

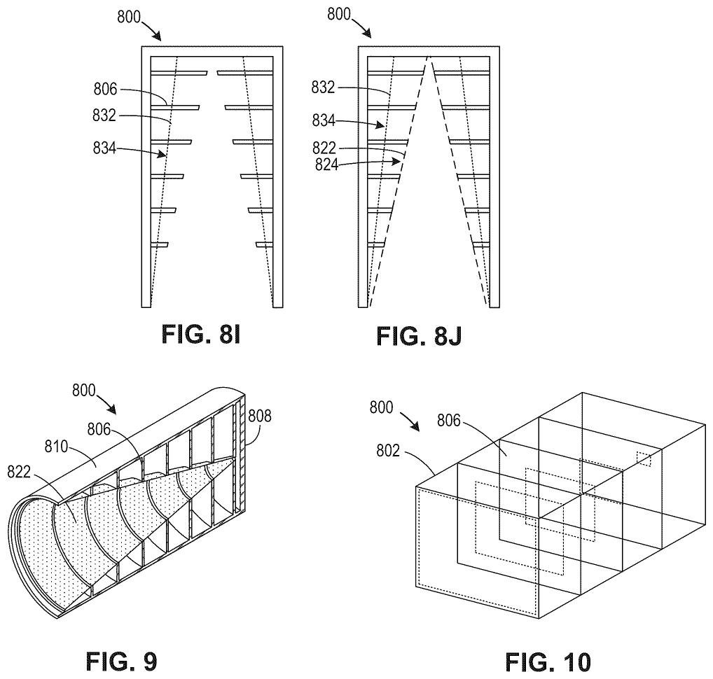

In some examples, the radially outer surface 418 includes a damping material to provide additional sound absorption to the first ABH assembly 402a. For example, the radially outer surface 418 can be lined with foam, vinyl, polytetrafluoroethylene (Teflon), adhesive, or another type of material including viscoelastic and acoustic damping materials. An example of the damping material is disclosed in further detail in connection with FIG. 8C. Furthermore, the first plates 425a and the second plates 425b can include damping material to increase the sound absorption capability of the first ABH assembly 402a and/or the second ABH assembly 402b. For example, the first plates 425a can include damping material (e.g., foam, Teflon, rubber, etc.) coupled to the base or root of each of the first plates 425a. In some examples, a layer of damping material is coupled to the length of the first plates 425a on one or both sides. An example of the damping material is disclosed in further detail in connection with FIG. 12B hereinbelow.

FIG. 5A is a cross-sectional front view of an example third VBV assembly 500a including a third ABH assembly 502a. FIG. 5B is a cross-sectional front view of an example fourth VBV assembly 500b including a fourth ABH assembly 502b. In some examples, the third VBV assembly 500a and/or the fourth VBV assembly 500b implement the first VBV assembly 400a of FIG. 4A and/or the second VBV assembly 400b of FIG. 4B. Furthermore, in some examples, the third ABH assembly 502a and/or the fourth ABH assembly 502b implement the first ABH assembly 402a of FIG. 4A and/or the second VBV assembly 400b of FIG. 4B. Thus, the third VBV assembly 500a of FIG. 5A and the fourth VBV assembly 500b of FIG. 5B can include the first or second ABH assembly 402a, 402b of FIG. 4A or 4B. The cross-sectional front view of the third and fourth VBV assemblies 500a, 500b shown in FIGS. 5A and 5B is taken along the lateral axis 426 of FIG. 4A. Unless otherwise specified, descriptions provided in connection with the third VBV assembly 500a of FIG. 5A likewise apply to the fourth VBV assembly 500b of FIG. 5B.

The third VBV assembly 500a includes the third ABH assembly 502a to absorb sound waves resonating radially outward from the VBV cavity 228. In the illustrated example of FIG. 5A, the third ABH assembly 502a includes the body 410 of FIGS. 4A and/or 4B, which extends circumferentially around a longitudinal axis 504 of the compressor 200. In the example of FIG. 5A, the body 410 is an annular structure defining the ABH cavity 412 (FIGS. 4A and/or 4B), which surrounds the VBV cavity 228. In some examples, the longitudinal axis 502 corresponds to the centerline axis 112 of FIG. 1. In some examples, the second dimension 424 (e.g., height) of the ABH cavity 412 is constant (e.g., constant within +/−10%) along the circumference of the door 404 (FIGS. 4A and/or 4B).

The third ABH assembly 502a of FIG. 5A can include the first plurality of plates 425a of FIG. 4A positioned within the ABH cavity 412. Thus, the first plates 425a can extend circumferentially around the longitudinal axis 502. The first plates 425a have an annular shape and variable diameters such that adjacent ones of the first plates 425a surround each other in a nested configuration.

In the illustrated example of FIG. 5B, the fourth ABH assembly 502b includes a plurality of partitions 506 coupled to the door 404 and an interior surface 508 (e.g., the radially outer surface 418 of FIGS. 4A and 4B). Additionally, in some examples, the plurality of partitions 506 are coupled to the fore interior surface 414 and the aft interior surface 416 of FIGS. 4A and 4B. Thus, the fourth ABH assembly 502b includes the partitions 506 of FIG. 5B to define a plurality of ABH cavities 510. Furthermore, in the illustrated example, ones of the partitions 506 are spaced circumferentially apart by an angle 512 (e.g., about 45 degrees, about 30 degrees, about 60 degrees, etc.). More specifically, a first partition 506a is radially and axially aligned with a first lateral axis 514, a second partition 506b is radially and axially aligned with a second lateral axis 516, and a third partition 506c is radially and axially aligned with a third lateral axis 518. The lateral axes 514-518 intersect and are orthogonal to the longitudinal axis 504 (e.g., the centerline axis 112 of FIG. 1) of the compressor 200. The second lateral axis 516 is oriented relative to the first lateral axis 514 by the angle 512. Similarly, the third lateral axis 518 is oriented relative to the second lateral axis 516 by the angle 512.

In some examples, respective ones of the plurality of partitions 506 are spaced circumferentially by the angle 512. Thus, the angle 512 can be based on a number of the partitions 506 included in the fourth ABH assembly 502b (e.g., eight of the partitions 506 corresponds to 45 degrees for the angle 512). Furthermore, volumes of the ABH cavities 510 are based on the angle 512 and the circumferential distance(s) between adjacent ones of the partitions 506. For example, the first and second partitions 506a, 506b define a first ABH cavity 510a, and the second and third partitions 506b, 506c define a second ABH cavity 510b. In some examples, the first and second ABH cavities 510a, 510b have the same volume. Alternatively, the first and second ABH cavities 510a, 510b can have different volumes. In some examples, a first portion of the ABH cavities 510 have a first volume and a second portion of the ABH cavities 510 have a second volume different than the first volume.

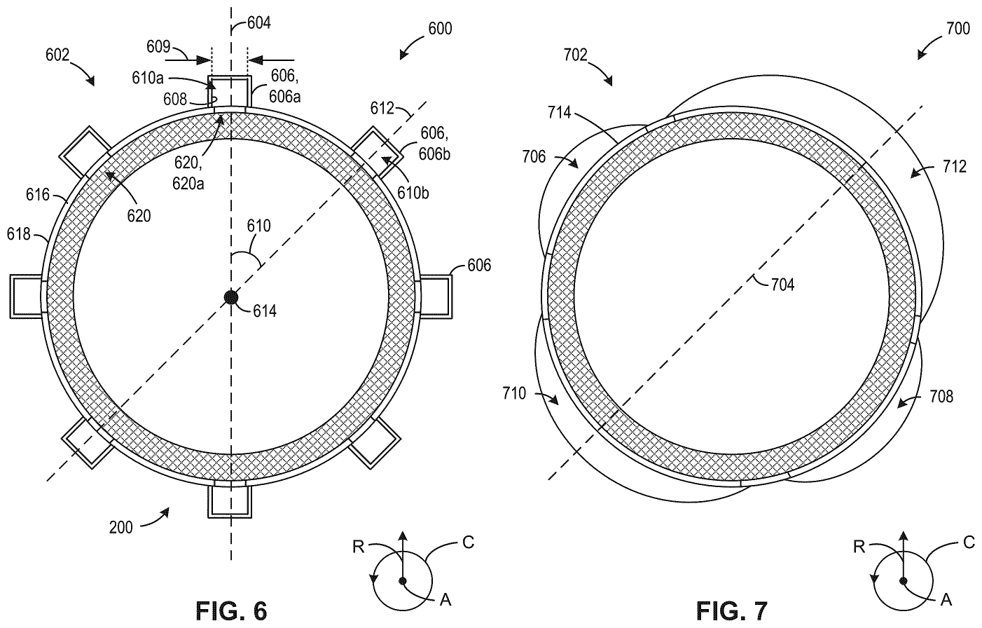

FIG. 6 is a cross-sectional front view of an example fifth VBV assembly 600 including an example fifth ABH assembly 602 in accordance with teachings disclosed herein. In some examples, the fifth ABH assembly 602 implements the first ABH assembly 402a of FIG. 4A or the second VBV assembly of FIG. 4B. The cross-sectional front view of the fifth VBV assembly 600 is taken along a first lateral axis 604. In some examples, the first lateral axis 604 of FIG. 6 corresponds to the lateral axis 426 of FIGS. 4A and 4B.

In the illustrated example of FIG. 6, the fifth ABH assembly 602 is an ABH plug assembly including a plurality of ABH plug bodies 606. The ABH plug bodies 606 are aligned with radial or lateral axes of the gas turbine engine 114 of FIG. 1 and/or the compressor 200. For example, the plurality of ABH plug bodies 606 includes a first ABH plug body 606a aligned with the first lateral axis 604. In some examples, the first ABH plug body 606a implements the body 410 of FIGS. 4A and/or 4B.

The first ABH plug body 606a can be a cylindrical body centered on the first lateral axis 604. For example, the first ABH plug body 606a of FIG. 6 is an open-top cylinder having an interior surface or wall 608 extending circumferentially around the first lateral axis 604. Furthermore, the first ABH plug body 606a can define an inner diameter 609. In some examples, the inner diameter 609 corresponds to the first dimension 422 (e.g., width) of FIGS. 4A and 4B. Alternatively, the first ABH plug body 606a is non-cylindrical and includes an ovular, rectangular, or triangular shape (e.g., cross-sectional profile).

In the illustrated example, the first ABH plug body 606a is similar or identical to the other ones of the plurality of ABH plug bodies 606. However, ones of the ABH plug bodies 606 can be of variable size (e.g., internal volume) and/or shape to adjust the range of resonant frequencies that the fifth ABH assembly 602 can dampen. For example, the fifth ABH assembly 602 can include the first ABH plug body 606a defining a first ABH cavity 610a and a second ABH plug body 606b defining a second ABH cavity 610b. Furthermore, the first ABH cavity 610a can have a first volume and the second ABH cavity 610b can have a second volume different than the first volume. Thus, in some examples, the first ABH plug body 606a can dampen a first resonant frequency (e.g., 200 Hz) and the second ABH plug body 606b can dampen a second resonant frequency (e.g., 400 Hz) greater than the first frequency when the internal volume of the first ABH plug body 606a is greater than the internal volume of the second ABH plug body 606b. In some examples, a first portion of the ABH plug bodies 606 have the volume of the first ABH cavity 610a and a second portion of the ABH plug bodies 606 have the volume of the second ABH cavity 610b. In other words, the first portion of the ABH plug bodies 606 can reduce a first frequency and a second portion of the ABH plug bodies 606 can reduce a second frequency different than the first frequency.

Furthermore, in the illustrated example, ones of the ABH plug bodies 606 are spaced circumferentially apart by an angle 610 (e.g., 45 degrees, 30 degrees, 60 degrees, etc.). More specifically, the second ABH plug body 606b is radially and axially aligned with a second lateral axis 612, which intersects the first lateral axis 604 and a longitudinal axis 614 (e.g., the centerline axis 112 of FIG. 1) of the compressor 200. The second lateral axis 612 is oriented relative to the first lateral axis 604 by the angle 610. In some examples, respective ones of the plurality of ABH plug bodies 606 are spaced circumferentially by the angle 610. Thus, the angle 610 can be based on the number of ABH plug bodies 606 included in the fifth ABH assembly 602 (e.g., eight of the ABH plug bodies 606 corresponds to 45 degrees for the angle 610). Alternatively, the plurality of ABH plug bodies 606 can be spaced circumferentially at variable angles.

In the illustrated example of FIG. 6, the plurality of ABH plug bodies 606 are coupled to a door 616 of the third ABH assembly 602. For example, the ABH plug bodies 606 can be fastened (e.g., bolted, welded, brazed, etc.) to an outer surface 618 of the door 616. Additionally or alternatively, one or more of the ABH plug bodies 606 can be integrated into the door 616 (e.g., based on casting, molding, additive manufacturing, etc.). Furthermore, the door 616 includes a plurality of holes 620 adjacent to the plurality of ABH plug bodies 606. For example, the door 616 includes a first hole 620a adjacent to the first ABH plug body 606a to permit oscillating air pressure (e.g., sound waves) to enter the first ABH cavity 610a. In some examples, a size the holes 620 corresponds to the inner diameter 609 of the ABH plug bodies 606. Furthermore, a shape of the holes 620 can correspond to a cross-sectional shape of the ABH plug bodies 606.

The plurality of ABH plug bodies 606 include a plurality of plates or discs (e.g., branch discs) to attenuate the acoustic resonance of the VBV cavity 228. In some examples, the ABH plug bodies 606 can include discs similar to the plates 425a or 425b of FIG. 4A or 4B. However, the first ABH plug body 606a includes discs coupled to the interior surface 608 such that the discs extend circumferentially around the first lateral axis 604. Furthermore, example plates/discs of the first ABH plug body 606a extend radially away from the interior surface 608 toward the first lateral axis 604. Thus, the plates of the first ABH plug body 606a include apertures aligned with (e.g., centered on) the first lateral axis 604. The plates are oriented substantially orthogonal (e.g., ±3°) to the first lateral axis 604. In some examples, the plates or discs increase in surface area along the first lateral axis 604 in the radially outward direction 428 (FIG. 4A), and the apertures decrease in diameter. By contrast, in other examples, the plates or discs can decrease in surface area along the first lateral axis 604 in the radially outward direction 428, and the apertures increase in diameter. In such examples, the first ABH plug body 606a can include a cone coupled to a radially outer surface (e.g., radially outer surface 418 of FIGS. 4A and 4B).

FIG. 7 is a cross-sectional front view of an example sixth VBV assembly 700 including an example sixth ABH assembly 702 in accordance with teachings disclosed herein. In some examples, the sixth ABH assembly 702 implements the first ABH assembly 402a of FIG. 4A or the second VBV assembly of FIG. 4B. The cross-sectional front view of the sixth VBV assembly 700 is taken along a first lateral axis 604. In some examples, the first lateral axis 704 of FIG. 7 corresponds to the lateral axis 426 of FIGS. 4A and 4B.

In the illustrated example of FIG. 7, the sixth ABH assembly 702 includes a first ABH cavity 706, a second ABH cavity 708, a third ABH cavity 710, and a fourth ABH cavity 712. The ABH cavities 706-712 of FIG. 7 can be additively manufactured to a door 714 (e.g., the door 404 of FIG. 4A) to provide different volumes for respective ones of the ABH cavities 706-712. For example, the first ABH cavity 706 can be smaller than the second ABH cavity 708, the second ABH cavity 708 can be smaller than the third ABH cavity 710, and the third ABH cavity 710 can be smaller than the than the fourth ABH cavity 712. The resonant frequency that an ABH body can dampen is based on the volume of the cavity that the body defines. Thus, the sixth ABH assembly 702 can dampen four different resonant frequencies based on the four different volumes of the ABH cavities 706-712. For example, the first ABH cavity 706 can dampen an 800 Hz resonant frequency, the second ABH cavity 708 can dampen a 600 Hz resonant frequency, the third ABH cavity 710 can dampen a 400 Hz resonant frequency, and the fourth ABH cavity 712 can dampen a 200 Hz resonant frequency.

FIGS. 8A-8J are cross-sectional views of various example ABH assembly designs that can be implemented in any of the example VBV assemblies disclosed herein. Any of the example features of the ABH assemblies of FIGS. 8A-8J can be combined or rearranged unless otherwise noted.

FIG. 8A shows an example ABH assembly 800 that includes a body 802 defining a cavity 804 and a plurality of plates 806 (one of which is referenced in FIG. 8A) in the cavity 804. The body 802 has an end wall 808 and a sidewall 810 that define the cavity 804. The sidewall 810 defines an inlet 812 into the cavity 804. The ABH assembly 800 can include any number of plates, including a first plate 806a closest to the inlet 812 and a final plate 806n closest to the end wall 808. The ABH assembly 800 has a longitudinal or center axis 814. The axis 814 may correspond to the radial direction of the gas turbine engine 114 (FIG. 1).

In the illustrated example of FIG. 8A, the plates 806 are coupled to and extend inward from the inner surface of the sidewall 810 of the body 802. In some examples, the sidewall 810 and the plates 806 are constructed as an integral component (e.g., a monolithic structure). In other examples, the plates 806 can be separate components that are coupled to the sidewall 810, such as via welding, brazing, threaded fasteners, an adhesive, etc. In some examples, the ABH assembly 800 is an individual plug assembly (e.g., as disclosed in connection with FIG. 6) that has a circular or cylindrical shape. In such an example, the plates 806 can be implemented as discs having central openings 816 (one of which is referenced in FIG. 8A) (e.g., an aperture) aligned with the axis 814. The diameter of the central openings 816 of the plates 806 decrease along the axis 814 from the inlet 812 toward the end wall 808. In other words, the central openings 816 in the plates 806 progressively reduce from the first plate 806a to the final plate 806n. This results in a tapering or conical-shaped flow path into the ABH assembly 800. In the illustrated example of FIG. 8A, the ABH assembly 800 includes six plates 806. However, in other examples, the ABH assembly 800 can include more or fewer plates. In some examples, the plates 806 are spaced equidistant from each other. In other examples, the plates 806 can be spaced further from or closer to each other.

While the example ABH assembly 800 is described as being a plug assembly having a circular or cylindrical shape, in other examples the ABH assembly 800 can be configured as a circumferential assembly that extends circumferentially around the gas turbine engine 114, similar to examples disclosed in connection with FIGS. 5A and 5B. In such an example, the sidewall 810 can be defined by two separate walls, including a first (fore) wall (e.g., the fore interior surface 414) and a second (aft) wall (e.g., the aft interior surface 416), and the plates 806 can be split into pairs of plates extending inward from the first and second walls.

FIG. 8B shows an example in which the ABH assembly 800 has additional plates 806 compared to the example shown in FIG. 8A. In some examples, increasing the number of plates 806 results in attenuating the feedback energy at higher rates and captures a wider range of frequencies.

FIG. 8C shows an example in which the ABH assembly 800 has a damping material 818 (which may also be referred to as a bulk absorber) in the space between the final plate 806n and the end wall 808. The damping material 818 can be constructed of a material with multiple passageways or materials, such as ¼ wave honeycomb acoustic absorbers, a shape memory alloy (SMA), polytetrafluoroethylene (PTFE), steel wool. The damping material 818 helps to dampen or attenuate the remaining acoustic frequencies not dampened/absorbed by the plates 806.

FIG. 8D shows an example of the ABH assembly 800 similar to FIG. 8C and also includes a structural damping layer 820 between the damping material 818 and the end wall 808. In some examples, the structural damping layer 820 includes viscoelastic or friction based dampers. The structural damping layer 820 further dissipates the energy and reduces the acoustics induced vibration transfer to the mechanical structure.

FIG. 8E shows an example in which the ABH assembly 800 includes a perforated facesheet 822. The perforated facesheet 822 is disposed in the cavity 804 and extends along the inner peripheral edges of the plates 806. The perforated facesheet 822 can be constructed of any material that can withstand temperature and pressure in the compressor, such as metal (e.g., steel). The perforated facesheet 822 has a plurality of openings 824 (one of which is referenced in FIG. 8E). Some of the acoustic waves can pass through the openings 824 and into the spaces between adjacent ones of the plates 806. As the acoustic waves at the desired frequency (ies) resonate in these side cavities, the oscillatory motion of the air through the perforated facesheet 822 allows for the conversion, and ultimately dissipation, of acoustic energy, thereby further reducing the acoustic response of the cavity 804.

FIG. 8F shows an example of the ABH assembly 800 similar to the example in FIG. 8E that includes the perforated facesheet 822. However, in FIG. 8F, the plates 806 are spaced in a non-linear arrangement. For example, the plates 806 near the inlet 812 are spaced further from each other, while the plates 806 closer to the end wall 808 are spaced closer to each other. In some examples, this non-linear spacing helps to improve effectiveness of the ABH assembly 800 in reducing and/or absorbing acoustics. Further, in the example of FIG. 8F, the ABH assembly 800 includes the damping material 818 in the space between the final plate 806n and the end wall 808.

FIG. 8G shows an example of the ABH assembly 800 similar to FIG. 8F and also includes a wire mesh sheet 826 along the perforated facesheet 822. The wire mesh sheet 826 helps to further dampen or attenuate acoustic waves in the air passing through the wire mesh sheet 826. In some examples, the ABH assembly 800 also includes a wire mesh absorber 828 in the space between the final plate 806n and the end wall 808.

FIG. 8H shows an example of the ABH assembly 800 similar to FIG. 8G and also includes structural dampers 830 on one or more of the plates 806. These structural dampers 830 absorb at least some of the resonant energy and dissipating this energy as heat, thereby eliminating the VBV cavity resonance. The structural dampers 830 serve to perform this dissipation of vibrational energy to heat.

FIG. 8I shows an example of the ABH assembly 800 including an example perforated septa 832. The perforated septa 832 is similar to the perforated facesheet 822 (FIGS. 8E-8H) but extends through the side cavities between the plates 806. The perforated septa 832 has a plurality of openings 834 (one of which is referenced in FIG. 8I). In some examples, as shown in FIG. 8J, the ABH assembly 800 includes both the perforated facesheet 822 and the perforated septa 832. In some examples, the openings 834 in the perforated septa 832 are smaller than the openings 824 in the perforated facesheet 822.

As disclosed above, in some examples, the ABH assembly 800 is a plug type assembly that may be symmetrical about the axis 814 (FIG. 8A). For example, FIG. 9 is a perspective cross-sectional view of the example ABH assembly 800. As shown, the body 802 is cylindrical-shaped. The plates 806 are disc-shaped. In FIG. 9, the ABH assembly 800 includes the perforated facesheet 822 of FIG. 8E.

In other examples, an ABH assembly can have a different shaped profile. For example, FIG. 10 shows an example of the ABH assembly 800 in which the body 802 is cuboid-shaped. For example, the body 802 may have a square or rectangular-shaped cross-section. In such an example, the plates 806 are also square or rectangular-shaped. In other examples, the ABH assembly 800 can have other shapes (e.g., a conical shape).

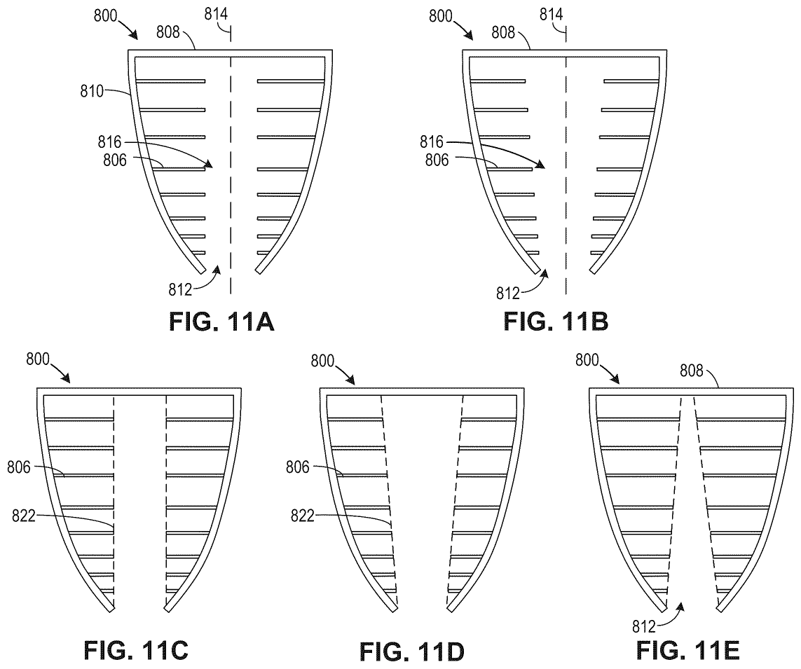

FIGS. 11A-11E show further variations of the ABH assembly 800 and that can be implemented in any of the example variable bleed valves disclosed herein. Any of the example features of the ABH assemblies of FIGS. 11A-11E can be combined or rearranged unless otherwise noted.

FIG. 11A shows an example of the ABH assembly 800 in which the outer diameter of the plates 806 varies. In particular, the outer diameter of the plates 806 increases along the axis 814 from the inlet 812 toward the end wall 808. As such, the diameter of the sidewall 810 increases along the axis 814 from the inlet 812 toward the end wall 808. In the illustrated example, the inner diameter of the central openings 816 in the plates 806 are constant or the same in all of the plates 806.

FIG. 11B shows an example of the ABH assembly 800 similar to FIG. 11A. However, in FIG. 11B, the inner diameter of the central openings 816 increases in diameter along the axis 814 from the inlet 812 toward the end wall 808.

FIG. 11C shows an example of the ABH assembly 800 similar to FIG. 11A in which the plates 806 have a varying outer diameter and a constant inner diameter. Further, in FIG. 11C, the ABH assembly 800 includes the perforated facesheet 822. In this example, the inner diameter of the plates 806 is constant, so the perforated facesheet 822 is cylindrical shape and/or otherwise has a constant diameter.

FIG. 11D shows an example of the ABH assembly 800 similar to FIG. 11B in which the plates 806 have a varying outer diameter and a varying inner diameter. Further, in FIG. 11D, the ABH assembly 800 includes the perforated facesheet 822.

FIG. 11E shows an example of the ABH assembly 800 similar to FIG. 11D, except in this example the inner diameter of the plates 806 decreases from the inlet 812 to the end wall 808.

In some examples, the plates 806 of the ABH assembly 800 can be tuned (e.g., via modulus and/or thickness) to structurally vibrate at certain frequency (ies) of interest. For example, FIG. 12A shows an example of the ABH assembly 800 with the plates 806 (one of which is referenced in FIG. 12A). In some examples, the ABH assembly 800 may include damping material (e.g., foam, Teflon, rubber) on the plates 806 (e.g., on the top and bottom surfaces of the plates 806) to help dampen acoustic energy absorbed by the plates 806.

FIG. 12B is an enlarged view of the callout 1200 of FIG. 12A showing the connection between an outer peripheral edge 1202 of the plate 806 and the sidewall 810 of the body 802. In some examples, as shown in FIG. 12B, the plate 806 has a reduced or tapered thickness near the outer peripheral edge 1202. For example, an outer peripheral section 1204 of the plate 806 has a smaller thickness than an inner peripheral section 1206 of the plate 806. The reduced thickness at the attachment area provides more flexibility to the plate 806 and therefore responds to higher frequencies than a plate with a uniform thickness. This reduced thickness profile also provides acoustic black hole absorption for the vibrational energy in the structure, thereby further dampening the sound from the VBV. This enables the plate 806 to operate similar to a tuning fork that is shaped and sized to vibrate a particular frequency or frequency band. This reduces the phase speed, which allows more time for the plate 806 to absorb the energy. As shown in FIG. 12B, the ABH assembly 800 can include damping material 1208 (e.g., foam, Teflon, rubber) coupled to the plate 806 along at least a portion of the outer peripheral section 1204 (e.g., applied to the top and bottom surfaces of the plate 806). The damping material 1208 acts to dampen or remove the acoustic energy from the plate 806. As such, the plate 806 is configured to attenuate or dampen acoustic vibrations at a particular frequency or frequency band. The other plates 806 can have the same reduced or tapered thickness or a different reduced thickness to attenuate or damper acoustic vibrations of different frequencies or frequency bands.

In some examples, the plate 806 can be shaped to improve damping. For example, FIG. 12C shows an example in which the outer peripheral section 1204 of the plate 806 has a larger thickness than inner peripheral section 1206. Further, in this example, the outer peripheral section 1204 that is connected to the sidewall 810 is fork-shaped. In some examples, the fork-shape connection provides a better path to transmit energy from the air to the sidewall 810. In some examples, the inner surface of the fork has a visco-elastic material coating.

Additionally or alternatively, the plates 806 can be manufactured with varying effective material density and/or elasticity to reduce phase speed. For example, FIG. 12D is a cross-sectional view of the plate 806 showing the internal material of the plate 806. The material of the plate 806 has a decreasing density from the inner peripheral edge to the outer peripheral edge (in the direction of the arrow), which decreases the effective phase speed as an alternative way to provide the ABH effect for the structure-borne energy as compared to the tapered thickness profile. In some examples, the plate 806 is constructed via additive manufacturing, such as 3D printing. The plate 806 can be constructed from internal structural members or via a foam. As the wave propagates through plate 806, the phase speed of the wave reduces and approaches 0 in the acoustic black hole.

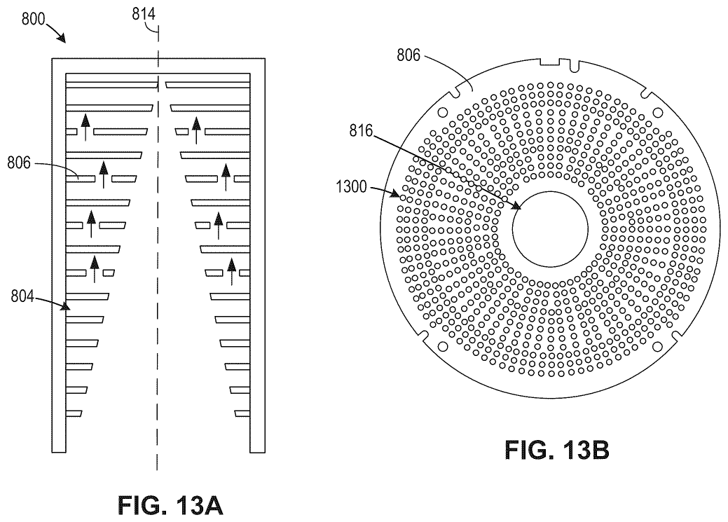

In some examples, one or more of the plates 806 can be perforated plates having one or more openings (besides the central opening 816). For example, FIG. 13A shows an example of the ABH assembly 800 in which multiple ones of the plates 806 have openings that allow acoustic air flow (as shown by the arrows) in the direction along the axis 814.

FIG. 13B is a top view of one of the plates 806 of FIG. 13A. The plate 806 has the central opening 816. The plate 806 also has a plurality of additional openings 1300 (one of which is referenced in FIG. 13B). As such, the plate 806 may be considered a perforated plate. In some examples, the openings 1300 are smaller than the central opening 816. The openings 1300 enable vibrational tuning to accept acoustic energy from the air to the plate 806 for additional damping.

In some examples, it is advantageous to maintain the same ratio of open area to closed area in each of the plates 806. In some examples, the open area ratio is calculated as a function of the disc fractional open area using:

$$π {r}^{′2} + σ π [ {R}^{2} - {r}^{′2} ] = π {r}^{2} \qquad Equation 1$$

$$∴ \frac{{r}^{′}}{R} = \sqrt{\frac{{( \frac{r}{R} )}^{2} - σ}{1 - σ}} \qquad Equation 2$$

In Equations 1 and 2, r is radius of the original central opening 816 (without perforations), R is the radius of the cavity 804, and r′ is the new radius of the central opening 816. Attaining the porosity with variable hole sizing and number of holes and hole shaping enables a designer to further tune the acoustic resistance for the airborne acoustics through the perforated plates, serving to provide damping to optimize ABH performance.

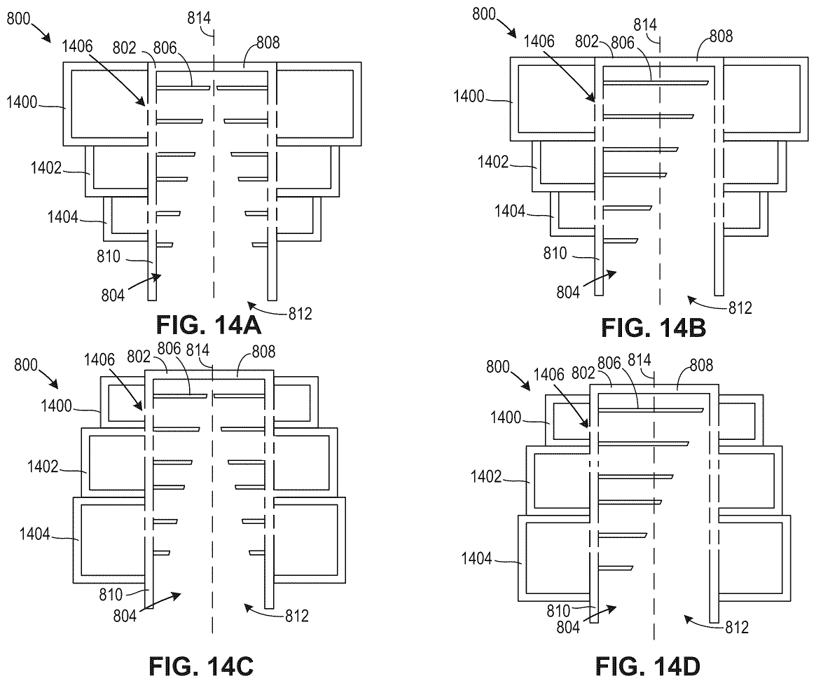

FIGS. 14A-14D show examples of the ABH assembly 800 including chambers that help to further dampen or attenuate acoustic energy. As shown in FIGS. 14A-14D, the body 802 includes chambers 1400, 1402, 1404 outside of (e.g., surrounding) the sidewall 810. The chambers 1400, 1402, 1404 may be cylindrical-shaped to match the shape of the sidewall 810. The sidewall 810 has openings 1406 (one of which is referenced in FIG. 14A) that extend in a radial direction relative to the axis 814. Acoustic waves from the cavity 804 can pass through the sidewall 810 and into the chambers 1400, 1402, 1404, which help to dampen the acoustic energy.

In some examples, the diameters of the chambers 1400, 1402, 1404 are varied. For example, in the examples of FIGS. 14A and 14B the diameter of the chambers 1400, 1402, 1404 increase from the inlet 812 toward the end wall 808, whereas in FIGS. 14C and 14D the diameter of the chambers 1400, 1402, 1404 decrease from the inlet 812 toward the end wall 808. The different diameters have the effect of attenuating or damping acoustic energy at different frequencies and/or frequency bands.

In some examples, the plates 806 may only be coupled to a certain portion or side of the sidewall 810. For example, in FIGS. 14B and 14C, the plates 806 are only coupled to the left side of the sidewall 810 (e.g., the fore wall).

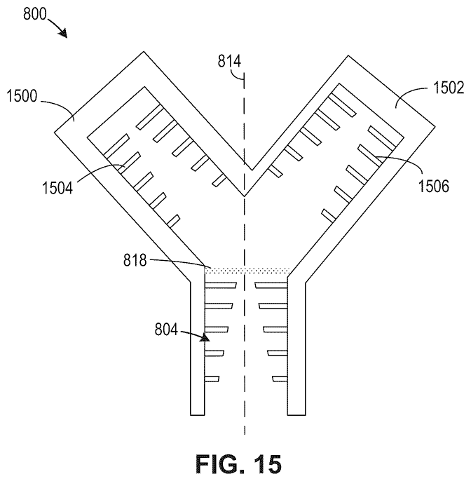

FIG. 15 illustrates an example of the ABH assembly 800 in which the body 802 includes two chambers 1500, 1502 that branch from the location of the end wall 808 (FIG. 8A). In this example, the chambers 1500, 1502 extend at angles relative to the axis 814. Each of the chambers 1500, 1502 has one or more plates 1504, 1506 (one of which is referenced in each of the chambers 1500, 1502). Any acoustic waves not attenuated in the cavity 804 can enter the first and second chamber 1500, 1502, where the acoustic energy is absorbed by the plates 1504, 1506. In the illustrated example, the ABH assembly 800 includes the damping material 818 between the cavity 804 and the chambers 1500, 1502.

Example variable bleed valve (VBV) assemblies are disclosed herein that include a VBV port extending radially outward from a compressor section of a gas turbine engine and a door positioned at an exit of the VBV port. The VBV port can produce significant noise at a resonant frequency based on internal dimensions of the VBV port as well as the flow conditions adjacent to the VBV port and a closed position of the VBV door. The resonant frequency can cause air pressure to increase at the VBV assembly and propagate to surrounding hardware such as a low pressure region of the gas turbine engine (e.g., booster section, booster or core inlet section, etc.). Such oscillations can excite mechanical components of the engine, such as rotor blades, discs and blisks, which can reduce performance of the engine, damage the components, increase wear, etc.

Some example VBV assemblies disclosed herein include an acoustic black hole (ABH) assembly coupled to the door. The ABH assembly includes a body and a plurality of plates (e.g., discs) coupled to an interior surface of the body. In some examples, the body of the ABH assembly extends circumferentially around a longitudinal axis of the gas turbine engine and defines a continuous ABH cavity. In some examples, the body of the ABH assembly corresponds to a first plug body included in a plurality of plug bodies. The first plug body is aligned with a lateral axis of the gas turbine engine and can have an open-top cylinder shape. The plates of the ABH assembly vary in size along a depth of the body in a radially outward direction. The plates vibrate based on the resonant frequency and convert acoustic energy from the VBV port into structural vibrational energy and ultimately heat. The energy conversion and wave interaction provided by the ABH assembly attenuates the noise associated with the resonant frequency of the VBV port. Thus, the ABH assembly absorbs the noise and reduces and/or eliminates reflection of the acoustic waves off of the door of the VBV port.

Examples and example combinations disclosed herein are provided in the following clauses:

A variable bleed valve assembly for a gas turbine engine, the variable bleed valve assembly comprising: a port extending radially outward from a main flow path of the gas turbine engine; a door positioned at an exit of the port; and an acoustic black hole (ABH) assembly coupled to the door, the ABH assembly including a body and a plurality of plates coupled to an interior surface of the body, the body defining a cavity having a depth, each of the plurality of plates having a surface area, the plurality of plates arranged such that the surface areas of the plurality of plates vary along the depth in a radially outward direction of the gas turbine engine.

The variable bleed valve assembly of any applicable preceding clause, wherein the plurality of plates are arranged such that the surface areas of the plurality of plates increase along the depth in the radially outward direction.

The variable bleed valve assembly of any applicable preceding clause, wherein the plurality of plates are discs having apertures with areas, and wherein the plurality of plates are arranged such that the areas of the apertures decrease in the radially outward direction.

The variable bleed valve assembly of any applicable preceding clause, wherein the plurality of plates are coupled to the interior surface of the body by a post.

The variable bleed valve assembly of any applicable preceding clause, wherein the ABH assembly extends circumferentially about a longitudinal axis of the gas turbine engine.

The variable bleed valve assembly of any applicable preceding clause, wherein the interior surface of the body is a fore interior surface, the body further including an aft interior surface and a radially outer surface, the aft interior surface spaced axially from the fore interior surface by a dimension.

The variable bleed valve assembly of any applicable preceding clause, wherein the dimension is constant along the depth of the body.

The variable bleed valve assembly of any applicable preceding clause, wherein the dimension is variable along the depth of the body.

The variable bleed valve assembly of any applicable preceding clause, wherein a first set of the plurality of plates extends axially outward from the fore interior surface, and a second set of the plurality of plates extends axially outward from the aft interior surface.

The variable bleed valve assembly of any applicable preceding clause, wherein the fore interior surface, the aft interior surface, and the radially outer surface define a rectangular cross-section of the body.

A gas turbine engine, comprising: a compressor section; and a variable bleed valve (VBV) assembly including: a VBV door; a port extending radially outward between the compressor section and the VBV door, the port defining a bleed flow path between the compressor section and the VBV door; and an acoustic black hole (ABH) assembly coupled to the VBV door, the ABH assembly including a body and a plurality of plates coupled to an interior surface of the body, the body defining a cavity having a depth, the plurality of plates having respective surface areas, the plurality of plates arranged such that the surface areas vary along the depth in a radially outward direction of the gas turbine engine.

The gas turbine engine of any applicable preceding clause, wherein the body extends circumferentially about a longitudinal axis of the gas turbine engine.

The gas turbine engine of any applicable preceding clause, wherein the interior surface of the body is a fore interior surface, the body further including an aft interior surface and a radially outer surface, the aft interior surface spaced axially from the fore interior surface.

The gas turbine engine of any applicable preceding clause, wherein a first set of the plurality of plates is coupled to the fore interior surface and a second set of the plurality of plates is coupled to the aft interior surface, the plurality of plates corresponding to rings surrounding the VBV door of the VBV assembly.

The gas turbine engine of any applicable preceding clause, wherein the ABH assembly includes a plurality of partitions coupled to the VBV door, the fore interior surface, the aft interior surface, and the radially outer surface, the plurality of partitions defining a plurality of ABH cavities, the plurality of partitions including a first partition, a second partition, and a third partition, the first partition and the second partition spaced circumferentially apart by a first angle, the second partition and the third partition spaced circumferentially apart by a second angle, the first and second partitions defining a first ABH cavity, the second and third partitions defining a second ABH cavity, the first ABH cavity including a first internal volume, the second ABH cavity including a second internal volume.

The gas turbine engine of any applicable preceding clause, wherein the first angle is same as the second angle, and the first internal volume is same as the second internal volume.

The gas turbine engine of any applicable preceding clause, wherein the first angle is different than the second angle, and the first internal volume different than the second internal volume.

An acoustic black hole assembly for a variable bleed valve assembly of a gas turbine engine, comprising: a body coupled to a door of the variable bleed valve assembly, the body defining a cavity having a depth and an internal volume, the body including an opening positioned adjacent to a hole in the door; and a plurality of plates coupled to an interior surface of the body, the plurality of plates extending outward from the interior surface, the plurality of plates arranged such that respective surface areas of the plurality of plates vary along the depth of the cavity in a radially outward direction of the gas turbine engine.

The acoustic black hole assembly of any applicable preceding clause, wherein the body is a first plug body included in a plurality of plug bodies, the first plug body corresponding to an open-top cylinder aligned with a lateral axis of the gas turbine engine, the interior surface extending circumferentially around the lateral axis, the plurality of plates corresponding to discs having apertures aligned with the lateral axis, the plates oriented substantially orthogonal to the lateral axis.

The acoustic black hole assembly of any applicable preceding clause, wherein the plurality of plates are arranged such that the surface areas of the plurality of plates increase along the depth in the radially outward direction, and aperture areas of the plurality of plates decrease along the depth in the radially outward direction.

Although certain example systems, apparatus, and articles of manufacture have been disclosed herein, the scope of coverage of this patent is not limited thereto. On the contrary, this patent covers all systems, apparatus, and articles of manufacture fairly falling within the scope of the claims of this patent.

The following claims are hereby incorporated into this Detailed Description by this reference, with each claim standing on its own as a separate embodiment of the present disclosure.

What is claimed is:

1. A variable bleed valve assembly for a gas turbine engine, the variable bleed valve assembly comprising:
a port extending radially outward from a main flow path of the gas turbine engine;
a door positioned at an exit of the port; and
an acoustic black hole (ABH) assembly coupled to the door, the ABH assembly including a body and a plurality of plates coupled to an interior surface of the body, the body defining a cavity having a depth, each of the plurality of plates having a surface area, the plurality of plates arranged such that the surface areas of the plurality of plates vary along the depth in a radially outward direction of the gas turbine engine.

2. The variable bleed valve assembly of claim 1, wherein the plurality of plates are arranged such that the surface areas of the plurality of plates increase along the depth in the radially outward direction.

3. The variable bleed valve assembly of claim 1, wherein the plurality of plates are discs having apertures with areas, and wherein the plurality of plates are arranged such that the areas of the apertures decrease in the radially outward direction.

4. The variable bleed valve assembly of claim 1, wherein the plurality of plates are coupled to the interior surface of the body by a post.

5. The variable bleed valve assembly of claim 1, wherein the ABH assembly extends circumferentially about a longitudinal axis of the gas turbine engine.

6. The variable bleed valve assembly of claim 1, wherein the interior surface of the body is a fore interior surface, the body further including an aft interior surface and a radially outer surface, the aft interior surface spaced axially from the fore interior surface by a dimension.

7. The variable bleed valve assembly of claim 6, wherein the dimension is constant along the depth of the body.

8. The variable bleed valve assembly of claim 6, wherein the dimension is variable along the depth of the body.

9. The variable bleed valve assembly of claim 6, wherein a first set of the plurality of plates extends axially outward from the fore interior surface, and a second set of the plurality of plates extends axially outward from the aft interior surface.

10. The variable bleed valve assembly of claim 6, wherein the fore interior surface, the aft interior surface, and the radially outer surface define a rectangular cross-section of the body.

11. A gas turbine engine, comprising:
a compressor section; and
a variable bleed valve (VBV) assembly including:
a VBV door;
a port extending radially outward between the compressor section and the VBV door, the port defining a bleed flow path between the compressor section and the VBV door; and
an acoustic black hole (ABH) assembly coupled to the VBV door, the ABH assembly including a body and a plurality of plates coupled to an interior surface of the body, the body defining a cavity having a depth, the plurality of plates having respective surface areas, the plurality of plates arranged such that the surface areas vary in a radially outward direction of the gas turbine engine.

12. The gas turbine engine of claim 11, wherein the body extends circumferentially about a longitudinal axis of the gas turbine engine.

13. The gas turbine engine of claim 12, wherein the interior surface of the body is a fore interior surface, the body further including an aft interior surface and a radially outer surface, the aft interior surface spaced axially from the fore interior surface.

14. The gas turbine engine of claim 13, wherein a first set of the plurality of plates includes is coupled to the fore interior surface and a second set of the plurality of plates is coupled to the aft interior surface, the plurality of plates corresponding to rings surrounding the VBV door of the VBV assembly.

15. The gas turbine engine of claim 13, wherein the ABH assembly includes a plurality of partitions coupled to the VBV door, the fore interior surface, the aft interior surface, and the radially outer surface, the plurality of partitions defining a plurality of ABH cavities, the plurality of partitions including a first partition, a second partition, and a third partition, the first partition and the second partition spaced circumferentially apart by a first angle, the second partition and the third partition spaced circumferentially apart by a second angle, the first and second partitions defining a first ABH cavity, the second and third partitions defining a second ABH cavity, the first ABH cavity including a first internal volume, the second ABH cavity including a second internal volume.

16. The gas turbine engine of claim 15, wherein the first angle is same as the second angle, and the first internal volume is same as the second internal volume.

17. The gas turbine engine of claim 15, wherein the first angle is different than the second angle, and the first internal volume different than the second internal volume.

18. An acoustic black hole assembly for a variable bleed valve assembly of a gas turbine engine, comprising:
a body coupled to a door of the variable bleed valve assembly, the body defining a cavity having a depth and an internal volume, the body including an opening positioned adjacent to a hole in the door; and
a plurality of plates coupled to an interior surface of the body, the plurality of plates extending outward from the interior surface, the plurality of plates arranged such that respective surface areas of the plurality of plates vary along the depth of the cavity in a radially outward direction of the gas turbine engine.

19. The acoustic black hole assembly of claim 18, wherein the body is a first plug body included in a plurality of plug bodies, the first plug body corresponding to an open-top cylinder aligned with a lateral axis of the gas turbine engine, the interior surface extending circumferentially around the lateral axis, the plurality of plates corresponding to discs having apertures aligned with the lateral axis, the plates oriented substantially orthogonal to the lateral axis.

20. The acoustic black hole assembly of claim 19, wherein the plurality of plates are arranged such that the surface areas of the plurality of plates increase along the depth in the radially outward direction, and aperture areas of the plurality of plates decrease along the depth in the radially outward direction.
